(19) United States
(12) Patent Application Publication
(10) Pub. No.: US 2017/0234499 A1
(43) Pub. Date: Aug. 17, 2017

(54) LIGHT MODULE FOR A HEADLAMP OF A VEHICLE WITH AT LEAST ONE ADJUSTMENT UNIT

(71) Applicant: Hella KGaA Hueck & Co., Lippstadt (DE)

(72) Inventors: Arathi PAI, Paderborn (DE); Sören SCHÄFER, Lippstadt (DE)

(21) Appl. No.: 15/502,697

(22) PCT Filed: Aug. 13, 2015
(86) PCT No.: PCT/EP2015/068611

§ 371 Date: Feb. 8, 2017

(30) Foreign Application Priority Data
Sep. 11, 2014 (DE) 10 2014 113 098.7

(51) Int. Cl. F21S 8/10

(52) U.S. Cl. CPC F21S 48/1742

(57) ABSTRACT

A light module for reception in a headlamp of a vehicle. The light module includes at least one light unit for the emission of light, and a carrier frame in which the light unit is held in the headlamp. At least one adjustment unit is also provided, by means of which the light unit can be moved in the headlamp around at least one adjusting axis. The adjustment unit has an eccentric gear with an output axle coinciding with the adjusting axis. A basic structure of the eccentric gear extends around the output axle in a disc-shaped manner.

The present invention relates to a light module for reception in a headlamp of a vehicle, at least comprising one light unit for the emission of light and comprising a carrier frame in which the light unit is held in the headlamp and wherein at least one adjustment unit is provided, by means of which the light unit can be moved in the headlamp around at least one adjusting axis.

### STATE OF THE ART

Known headlamps for vehicles have light modules which are movably held in the headlamp housing, and the movement of the light module in the headlamp housing is often executed in a highly dynamic manner. With regard to the swiveling of the light module in the headlamp for the generation/dynamization of, for example, bend lighting, a dazzle-free high beam or a marker light, actuators and gears are driven, which need to comply with the respective specific requirements. In addition to a long service life, the requirements include high torque, high movement speed, high angular accuracy, and a correspondingly high resolution. Often, the mass and torques requirements in combination with the angle resolution requirements are so high, that complicated actuator and gear tuning is required. Furthermore, translatory drive units are mainly being used, which first need to be converted into a rotatory movement of the light module usable by means of gear or lever movements.

The light unit can for example be moved around a first, horizontal adjustment unit in the carrier frame. By this means, e.g., a dazzle-free high beam can be adjusted or the cut-off line of a low beam can be set, e.g. depending on the inclination angle of the vehicle. The carrier frame with the light unit can be swiveled around a further, e.g. vertically arranged adjustment axis in the headlamp housing, e.g. to fulfill a bend lighting function. Particularly due to the need for at least two adjustment units, the motor-gear-units are often very complex and they take up a large amount of installation space, which is often not available in a headlamp housing. Particularly in cases in which the first adjustment unit for the swiveling of the light unit in a horizontal axis swivels along with the carrier frame when the carrier frame is swiveled with the light unit and the first adjustment unit around a vertical axis in the headlamp housing, the first adjustment unit takes up much swivel space when the light unit is swiveled around the horizontal axis. This needs to be provided in the housing of the headlamp in an elaborate manner.

In an exemplary manner, DE 10 2006 024 779 A1 shows a light module for the reception in a headlamp of a vehicle having an adjustment unit comprising a motor and a gear. The output axle of the gear is connected to the light unit with a crank and a coupling rod, so that it can be moved in the carrier frame. Disadvantageously, a rotational movement provided by the motor-gear-unit needs to be transformed into a linear movement via a crank, which in turn is applied to the coupling rod. The linear movement from the coupling rod is then transformed into a swivel movement of the light unit around an adjusting axis. This causes major installation space requirements and due to the many coupling elements contained in the moving system, the angular accuracy cannot fulfill high demands.

DE 199 05 173 B4 shows a further example of a light module being held in a headlamp of a vehicle, and the light module can be moved via a drive motor by means of a coupling rod being called adjusting element. Therefore, also in this execution a rotational movement of the drive is transformed into a linear movement of the coupling rod, which in turn swivels the light module around an axis.

In an automotive application, high demands are made on light modules with regard to their effect on the environment, particularly relating to high motion dynamics and to a high degree of angular accuracy of the movement.

For current systems to fulfill these target values they have either large actuators with or without gears or they have small actuators with complex and multi-stage gears to ensure a larger speed reduction, and particularly to achieve larger adjustment torques. These solutions require extensive installation space and lead to larger weights which in turn lead to additional energy consumption in the vehicle. When a small motor with standard gears is used, this leads to an increase in the number of component parts and therefore to an increase in system complexity.

### DISCLOSURE OF THE INVENTION

The task of the invention relates to the further development of a light module with at least one adjustment unit, wherein the adjustment unit shall fulfill high demands with regard to adjusting speed and angular accuracy and the adjustment unit shall be as small as possible. In particular, it is to be avoided that the coupling of the adjustment unit with the light unit is, even partially, formed by a linear movement.

This task is solved on the basis of a light module according to the preamble of claim 1 and according to the preamble of claim 8 in connection with the respective characterizing features. Advantageous further developments of the invention are indicated in the dependent claims.

The invention includes the technical teaching, that the adjustment unit includes an eccentric gear with an output axle coinciding with the adjusting axis and wherein a basic structure of the eccentric gear extends in a disc-shaped manner around the output axle.

The invention is based on the idea that eccentric gear can be executed in a very flat manner, so that the required installation space of an adjustment unit having an eccentric gear according to the invention will be very small. An eccentric gear can have a disc-shaped layout due to their function, and a disc-shaped basic body of the eccentric gear can be integrated in a particularly advantageous manner in the light module.

To be able to use the further advantages of eccentric gear, the disc-shaped basic structure of the eccentric gear according to the invention extends around its output axle, so that the disc-shaped basic structure of the eccentric gear extends at the same time also around the adjusting axis around which the light unit can be moved in the headlamp. This leads to a particularly compact design, and according to a particular advantage, the output axle of the eccentric gear is directly coupled with the light unit, so that the rotary movement of the output axle is identical with the rotary movement of the light unit. In particular, there are no further coupling elements between the eccentric gear and the light unit, as according to the invention the output axle is directly coupled with the light unit. The direct coupling is achieved by the synchronous rotary movement of the output axle and the light unit. Herein, the output axle can also be coupled with the carrier frame or the output axle is connected to a component which is an integral part of housing of the headlamp, while the disc-shaped basic structure of the eccentric gear is coupled with the carrier frame. The form of coupling is herein subordinate to the structural characteristic that the movement of the light unit around the respective adjusting axis is identical with the rotary movement of the output axle of the eccentric gear relative to the basic structure of the eccentric gear with regard to speed, direction of rotation and axis of rotation.

Particularly advantageously a structural component part of the eccentric gear can be embodied by a part of the carrier frame. For example, the structural component part can be embodied by a hollow wheel of the eccentric gear, and the hollow wheel can be an internally geared wheel, with which the outer teeth of a toothed wheel of the eccentric gear mesh. Herein, the hollow wheel can be embodied in a particularly advantageous manner by part of the carrier frame. The hollow wheel can also be embodied by part of the light unit, for example by a basic structure or by a frame.

According to an advantageous further development of the light module, a first adjustment unit can be provided, by means of which the light unit can be swiveled in a horizontal adjusting axis on the carrier frame. Furthermore, a second adjustment unit can be provided, by means of which the carrier frame can be swiveled together with the light unit around a vertical adjusting axis. The first adjustment unit can be used for the leveling of the light provided by the light unit. The second adjustment unit can be provided to fulfill a bend lighting function.

Therefore, the first adjustment unit swivels the light unit for example around a horizontal axis, and the adjustment unit can be arranged between the light unit and the carrier frame. The second adjustment unit swivels the light unit around a vertical axis and it can be arranged between the headlamp housing and the carrier frame. Therefore, the output axle can for example be connected to a component part which is an integral part of the housing, and the disc-shaped basic body of the eccentric gear can be arranged on the carrier frame or the carrier frame forms part of the basic structure of the eccentric gear, for example the hollow wheel. If the adjustment unit is placed between the carrier frame and the light unit, part of the carrier frame can, again, form the hollow wheel of the eccentric gear, and the output axle of the eccentric gear is connected to the light unit itself.

According to an advantageous further embodiment of the light module, the adjustment unit can have a motor, wherein the motor is also particularly embodied in a disc-shaped manner and is arranged preferably plane-parallel on the disc-shaped eccentric gear. Disc-shaped motors are known as so-called stepper-motors or brushless direct-current motors, which can be executed in a very flat manner and have a high torque. Herein, the advantage derives from the fact that the adjustment unit is made from exclusively rotationally moving component parts, in particular without coupling elements between the motor and the light unit executing a linear movement, which in turn would have to be transformed into a rotary or swiveling movement of the light unit.

As the motor and the eccentric gear are closely positioned, the advantage can be used that the eccentric gear and the motor together form a structural unit which can be arranged on the hollow wheel, wherein the hollow wheel completes the eccentric gear only when is is added. In particular, the eccentric gear and preferably also the mounted motor can be held via the hollow wheel being embodied as a structural section of the carrier frame.

Furthermore, the invention relates to an adjustment unit for the movement of a light unit of a light module in a headlamp of a vehicle, wherein the light unit is movable in at least one adjusting axis, and it is envisaged that the adjustment unit has eccentric gear with a output axle coinciding with the adjusting axis and wherein a basic structure of the eccentric gear extends in a disc-shaped manner around the output axle.

In a particularly advantageous embodiment, the eccentric gear can have a hollow wheel being formed by part of a carrier frame, by which the light unit is held in the headlamp. In particular, the adjustment unit can have a motor, wherein the motor is particularly embodied in a disc-shaped manner and is preferably arranged in a plane-parallel manner on the disc-shaped eccentric gear.

With the embodiment of a light module and an adjustment unit according to the invention, highly dynamic light functions for a headlamp can be realized, wherein movements of the light unit are exclusively based on rotary movements. By this means, loss of efficiency is minimized, and an achievable angular accuracy may reach particularly good values. In particular, the adjustment unit can be executed in a very space-saving design, and large reductions can be achieved between the motor and the output axle of the eccentric gear, for example a ratio of more than 1:100. A further advantage is the possible play-free embodiment of eccentric gear.

Herein, the embodiment of the adjustment unit with eccentric gear in the sense of the invention comprises all designs of gears and modes of action of gears in which at least one eccentrically embodied and/or one eccentrically guided or moved active component of the gear is provided, so that the term “eccentric gear” under consideration serves as a comprehensive term for all respective designs of gears. A particular advantage is achieved when the eccentric gears are for gears are for example embodied as planetary gears or cycloidal gears. Especially cycloidal gears feature a particular freedom from play, allow operation with minimal noise development at high reduction ratios and they are self-locking. Planetary gears, which are also called eccentric gears in the sense of the present application of the term, can also be used advantageously.

The result is an adjustment unit with a high torque and good longevity due to only partial use of the meshing toothed wheels of the eccentric gear, particularly of the cycloidal gear, which can be operated with the minimum amount of vibration and noise. Also, the single stage design of the gear is particularly suitable for the present application, as is requires particularly little installation space. The minimal installation space requirement results especially from a coaxial arrangement of the drive and output axle of the eccentric gear; and the output axle of the motor can coincide with the output axle of the eccentric gear, wherein the axles of the motor and the gear again can coincide with the adjusting axes of the light unit.

### PREFERRED EMBODIMENT OF THE INVENTION

Further measures improving the invention are described below in combination with a preferred embodiment of the invention by means of the figures. The figures show:

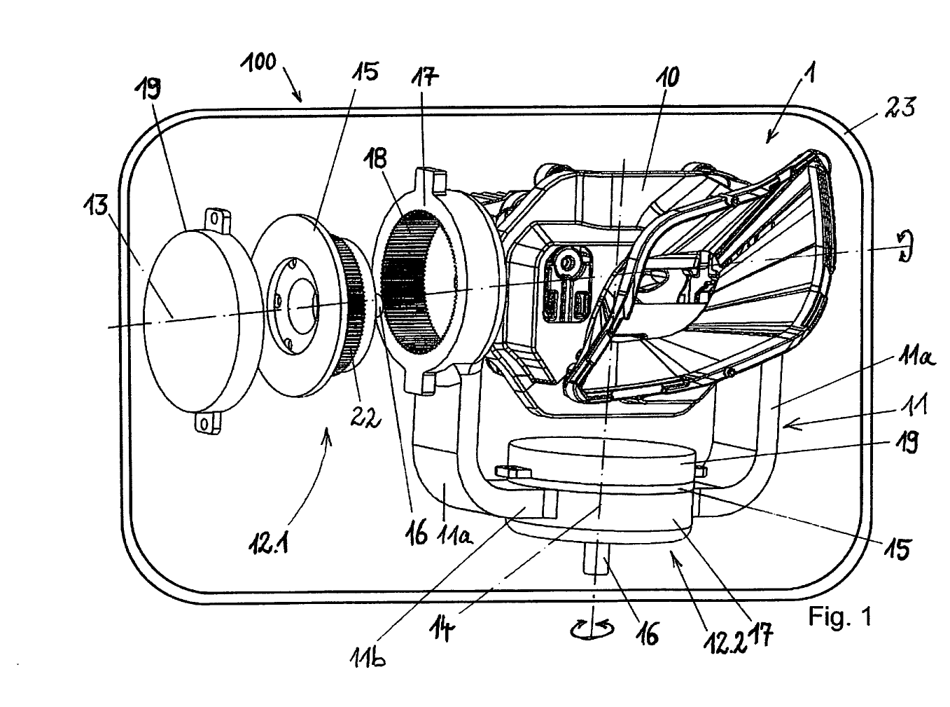

FIG. 1 A perspective view of a light module with adjustment units for the movement of a light unit of a light module, wherein an adjustment unit is shown in an exploded view.

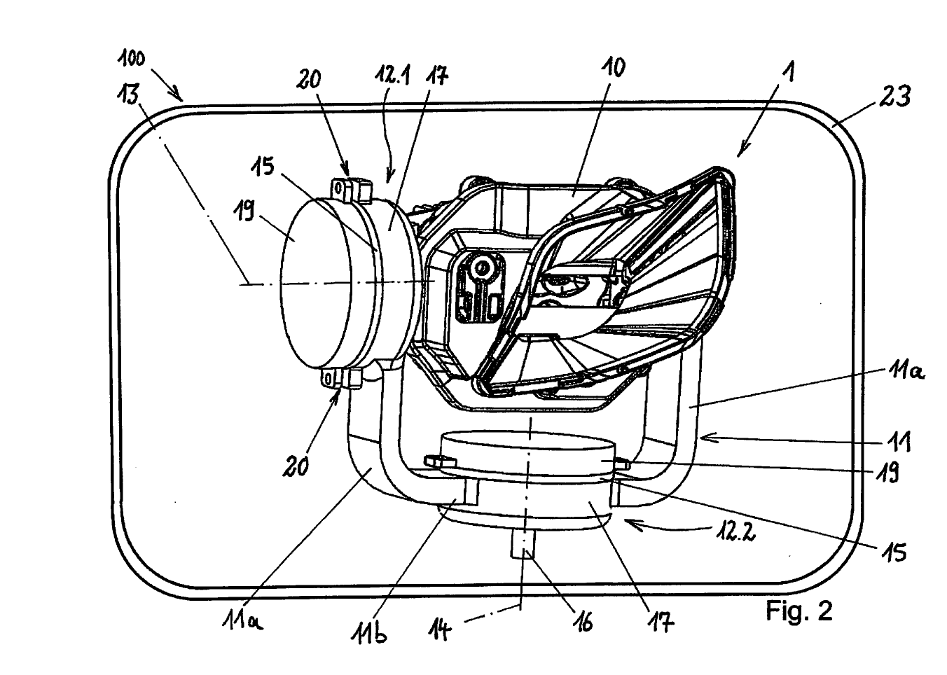

FIG. 2 A perspective view of the light module according to FIG. 1 in the assembled state.

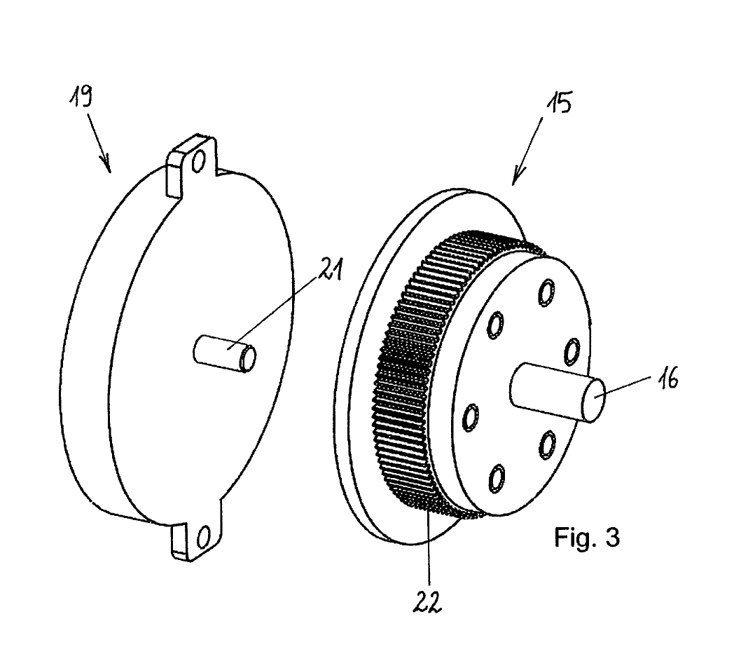

FIG. 3 A perspective view of the motor and the eccentric gear used to form an adjustment unit.

FIGS. 1 and 2 show a perspective view of a light module 1 being received in a headlamp 100, wherein the headlamp 100 is represented only in a schematic manner by a headlamp housing 23. The light module 1 has a light unit 10, and the light unit 10 is movably held in the headlamp housing 23 of the headlamp 100 via a carrier frame 11 of the light module 1. The light unit 10 serves the emission of light, for example for the forming of a low beam and/or a high beam.

The light unit 10 can be swiveled in an adjusting axis 13 on the carrier frame 11, and the adjusting axis 13 runs in a horizontal direction. When the light unit 10 swivels around the adjusting axis 13, a light range of the light being provided by the light unit 10 can for example be changed. The adjusting axis 14 runs vertical, and the carrier frame 11, together with the light unit 10 can swivel around the adjusting axis 14. By swiveling the light unit 10 around the adjusting axis 14, a bend lighting function of the headlamp 100 can for example be realized.

An adjustment unit 12.1 serves to swivel the light unit 10 around the adjusting axis 13 on the carrier frame 11, and an adjustment unit 12.2 serves to swivel the carrier frame 11 together with the light unit 10 around the adjusting axis 14; and the adjustment unit 12.1 and 12.2 each have an eccentric gear 15. The eccentric gears 15 have an output axle 16 coinciding with the respective adjusting axes 13 and 14. The output axle 16 of the adjustment unit 12.1 can have a direct connection with the frame of the light unit 10, and the output axle 16 of the adjustment unit 12.2 can have a connection with a component part in the headlamp 100, for example also with the headlamp housing 23.

In a particular manner, the carrier frame 11 forms a structural component of the eccentric gear 15, and the adjustment units 12.1 and 12.2 furthermore have a motor 19, and the motor 19 and the eccentric gear 15 are each embodied in a disc-shaped manner and are arranged lying on top of each other. The structural component of the eccentric gear 15 is formed by a hollow wheel 17, so that the eccentric gear 15—with the exception of the hollow wheel 17—is arranged with the motor 19 on the hollow wheel 17. For the connection of the eccentric gear 15 with the motor 19, connecting means 20 are used, by means of which for example a screwed connection between the motor 19 and the eccentric gear 15 with the hollow wheel 17 can be executed.

The carrier frame 17 is embodied in a u-shaped manner and has two limbs 11a, which are connected via a basic section 11b of the carrier frame 11. The adjustment unit 12.1 for the swiveling of the light unit 10 around the adjusting axis 13 is arranged on a free end of a limb 11a of the carrier frame 11, in which the hollow wheel 17 forms the free end of the limb 11a and is integrally formed onto the carrier frame 11 and is made from the same material. The hollow wheel 17 has an internal toothing 18 which meshes with a toothed wheel 22 of the adjustment unit 12.1. The toothed wheel 22 is merely shown in a one-piece version, but it can also be embodied in a two-piece version, wherein the toothed wheel parts can for example have differing numbers of teeth.

The adjustment unit 12.2 is arranged centrally in the basic section 11b of the carrier frame 11. To this end, the hollow wheel 17 is embodied by a central structural section of the basic section 11b of the carrier frame 11. The eccentric gear 15 sits on top of the hollow wheel 17 and engages in it, and the motor 19 of the adjustment unit 12.2 is arranged above the eccentric gear 15.

When the adjustment units 12.1 and 12.2 are activated by powering the motors 19, the output axles 16 of the adjustment units 12.1 and 12.2 are rotated relative to the hollow wheels 17, so that a swiveling of the light unit 10 around the adjusting axes 13 and 14 is achieved. When activating the adjustment unit 12.1, the light unit 10 is swiveled around the adjusting axis 13 on the carrier frame 11, and when the adjustment unit 12.2 is activated, the carrier frame 11, with the light unit 10 and the first adjustment unit 12.1, is swiveled around the adjusting axis 14.

In a perspective view, FIG. 3 shows an eccentric gear 15 and a motor 19. The eccentric gear 15 extends in a disc-shaped manner around the output axle 16, and the motor 19 has a motor output axle 21 which coincides with the output axle 16 in a mounted arrangement of the motor 19 on the eccentric gear 15. Furthermore, the toothed wheel 22 of the eccentric gear 15 is represented, which meshes with the internal toothing 18 of the hollow wheel 17, when the eccentric gear 15 is arranged on the hollow wheel 17.

In principle, the term eccentric gear 15 also refers to the hollow wheel 17, which is executed as a structural component of the carrier frame 11. The shown eccentric gear 15 is therefore not represented fully, the hollow wheel 17 not being shown for drawing reasons only.

In its execution, the invention is not limited to the preferred embodiment described above. Rather, a multitude of variants employing the represented solution also in fundamentally different executions is conceivable. All characteristics and/or advantages arising from the claims, the description, or the drawings, including design details or spatial arrangement, can be essential for the invention, either on their own or in the most different combinations. In an exemplary manner, the hollow wheel 17 can also a structural element of the light unit 10, while the eccentric gear 15 can be formed on the carrier frame 11, or at least be arranged on it. There is also the option of executing the hollow wheel 17 as a structural component of the headlamp housing 23, while the (remaining) eccentric gear 15 is formed or arranged on the carrier frame 11. According to a further variant, the motor 19 can also be formed on the light unit 10, and the eccentric gear 15 can be arranged on the motor 19 in a holding manner. In the same manner, the motor 19 can also be held in the headlamp housing 23, and the eccentric gear 15 is held on the motor 19, and the carrier frame 11 can be held on the eccentric gear 15 in a rotationally driven manner.

Independent of the installation position of the adjustment unit 12.1 and 12.2, the driving of the swiveling movement of the light unit 10 around the respective adjusting axis 13, 14 is based on the rotary movement of the output axle 16 relative to the basic body of the eccentric gear 15.

### LIST OF REFERENCE NUMBERS

### 100 Headlamp

1 light module
10 Light unit
11 Carrier frame

### 11a Limb

11b Basic section
12.1 Adjustment unit
12.2 Adjustment unit
13 Adjusting axis
14 Adjusting axis
15 Eccentric gear
16 Output axle
17 Hollow wheel
18 Internal toothing

### 19 Motor

20 Connecting means
21 Motor output axle
22 Toothed wheel
23 Headlamp housing

1. A light module for reception in a headlamp of a vehicle, said light module comprising:
at least one light unit for the emission of light;
a carrier frame in which the at least one light unit is held in the headlamp,
at least one adjustment unit, by means of which the light unit can be moved in the headlamp around at least one adjusting axis,
wherein the adjustment unit includes an eccentric gear with an output axle coinciding with the adjusting axis and
wherein a basic structure of the eccentric gear extends around the output axle in a disc-shaped manner.

2. The light module according to claim 1, wherein a structural component of the eccentric gear is formed by a part of the carrier frame.

3. The light module according to claim 1 or wherein the eccentric gear has a hollow wheel with an inner toothing, the hollow wheel being formed by a part of the carrier frame.

4. The light module according to claim 1., wherein a first adjustment unit is provided, by means of which the light unit can be swiveled on the carrier frame around a horizontal adjusting axis.

5. The light module according to claim 4, wherein a second adjustment unit is provided, by means of which the carrier frame with light unit can be swiveled around a vertical adjusting axis.

6. The light module according to claim 3, wherein the adjustment unit (12.1, 12.2) has a motor, the motor being embodied particularly in a disc-shaped manner and being arranged preferably in a plane-parallel manner on the disc-shaped eccentric gear.

7. The light module according to claim 6, wherein the eccentric gear and the motor form a structural unit arrangeable on the hollow wheel.

8. An adjustment unit for the movement of a light unit of a light module in a headlamp of a vehicle, wherein the light unit is movable in at least one adjusting axis, said adjustment unit comprising:
an eccentric gear with an output axle coinciding with the adjusting axis,
wherein a basic structure of the eccentric gear extends around the output axle in a disc-shaped manner.

9. The adjustment unit according to claim 8, wherein the eccentric gear has a hollow wheel being formed by a part of a carrier frame holding the light unit in the headlamp.

10. The adjustment unit according to claim 9, wherein the adjustment unit has a motor, the motor being embodied particularly in a disc-shaped manner and being arranged preferably in a plane-parallel manner on the disc-shaped eccentric gear.
